(19) United States
(12) Patent Application Publication
(10) Pub. No.: US 2023/0128940 A1
(43) Pub. Date: Apr. 27, 2023

(54) MODULAR RETAIL DISPLAY SYSTEM

(71) Applicant: Target Brands, Inc., Minneapolis, MN (US)

(72) Inventors: Jason W. Johnson, Wayzata, MN (US); Jennifer A. Theisen, Crystal, MN (US); Rachel R. Riddle, Minneapolis, MN (US); Mauro Pasinelli, Kenmore, WA (US); Jonathan T. Leckie, Edmonds, WA (US); Matthew P. Tomcsanyi, Festus, MO (US); Michael J. Baldwin, Winfield, MO (US); Luke Tabara, Apple Valley, MN (US)

(21) Appl. No.: 17/509,372

(22) Filed: Oct. 25, 2021

(51) Int. Cl. A47F 5/10; F16B 12/10

(52) U.S. Cl. CPC A47F 5/108; F16B 12/10

(57) ABSTRACT

Each of a first and a second display unit includes a base and a wall that extends upwardly from a top of the base. Each base of the first and second display units has at least male-type attachment mechanism accessible from the top of the base and at least one female type attachment mechanism accessible from the top of the base. The at least one male-type attachment mechanism of the first mobile display unit is configured to engage with the at least one female-type attachment mechanism of the base of the second mobile display unit and the at least one male-type attachment mechanism of the second mobile display unit is configured to engage with the at least one female-type attachment mechanism of the base of the first mobile display unit to secure the first and second mobile display units together.

### BACKGROUND

Retail stores use a variety of retail display units to present products to customers for purchase. These display fixtures can support the product or products, indicate the product price, and include signage for highlighting the product. Exemplary display structures include shelves, risers, bins, buckets and other similar structures.

The discussion above is merely provided for general background information and is not intended to be used as an aid in determining the scope of the claimed subject matter.

### SUMMARY

A modular retail display system includes first and second freestanding display units. The first freestanding display unit includes a base deck and a wall that extends upwardly from the base deck. The base deck of the first freestanding display unit has at least one male-type attachment mechanism accessible from a top of the base deck and at least one female-type mechanism accessible from the top of the base deck. The second freestanding display unit includes a base deck and a wall that extends upwardly from the base deck. The base deck of the second freestanding display unit has at least one male-type attachment mechanism accessible from a top of the base deck of the second freestanding display unit and at least one female-type mechanism accessible from the top of the base deck of the second freestanding display unit. The at least one male-type attachment mechanism of the first freestanding display unit is configured to engage with the at least one female-type attachment mechanism of the second freestanding display unit and the at least one male-type attachment mechanism of the second freestanding display unit is configured to engage with the at least one female-type attachment mechanism of the first freestanding display unit to secure the first freestanding display unit to the second freestanding display unit.

A modular retail display system includes first and second mobile display units. The first mobile display unit includes a base deck and a wall that extends upwardly from a top of the base deck. The base deck of the first mobile display unit has at least one pin rotatable in and inseparable from a first aperture and at least one second aperture. The second mobile display unit includes a base deck and a wall that extends upwardly from a top of the base deck. The base deck of the second mobile display unit has at least one pin rotatable in and inseparable from a first aperture and at least one second aperture. A prong portion of the at least one pin of the first mobile display unit is configured to engage with the at least one second aperture of the base deck of the second mobile display unit and a prong portion of the at least pin of the second mobile display unit is configured to engage with the at least one second aperture of the base deck of the first mobile display unit to secure the first mobile display unit to the second mobile display unit.

A method of configuring a modular retail display system includes moving a first mobile display unit adjacent to a second mobile display unit. The first mobile display unit includes a base deck and a wall that extends upwardly from the base deck and the second mobile display unit includes a base deck and a wall that extends upwardly from the base deck. The base deck of the first mobile display unit has at least one pin slidable in and inseparable from a first aperture and at least one second aperture and the second mobile display unit has at least one pin slidable in and inseparable from a first aperture and at least one second aperture. The first mobile display unit is secured to the second mobile display unit by lifting the at least one pin of the base deck of the first mobile display unit, rotating the at least one pin inside the first aperture of the base deck of the first mobile display unit, inserting a prong portion of the at least one pin of the base deck of the first mobile display unit into the second aperture of the base deck of the second mobile display unit, lifting the at least one pin of the base deck of the second mobile display unit, rotating the at least one pin inside the first aperture of the base deck of the second mobile display unit and inserting a prong portion of the at least one pin of the base deck of the second mobile display unit into the second aperture of the base deck of the first mobile display unit.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 illustrates a perspective view of a freestanding endcap display unit according to an embodiment.

FIG. 2 illustrates a back view of the freestanding endcap display unit of FIG. 1.

FIG. 3 illustrates a section view of the freestanding endcap display unit of FIG. 1 taken through the section line in FIG. 2.

FIG. 4 illustrates a section view of the freestanding endcap display unit of FIG. 1 taken through the section line in FIG. 2.

FIG. 5 illustrates a section view of the freestanding endcap display unit of FIG. 1 taken through the section line in FIG. 2.

FIGS. 6a illustrates an enlarged view of a portion of the section view of the freestanding endcap display unit as indicated in FIG. 3 with a male-type attachment mechanism ready for attachment.

FIG. 6b illustrates FIG. 6a, but with the male-type attachment mechanism located in a stowed configuration.

FIG. 7 illustrates an enlarged view of a portion of the section view of the freestanding endcap display unit as indicated in FIG. 3.

FIG. 8a illustrates an enlarged view of a portion of the section view of the freestanding endcap display unit as indicated in FIG. 4 with the male-type attachment mechanism ready for attachment.

FIG. 8b illustrates FIG. 8a, but with the male-type attachment mechanism located in a stowed configuration.

FIG. 9 illustrates an enlarged view of a portion of the section view of the freestanding endcap display unit as indicated in FIG. 5.

FIG. 10 illustrates a first freestanding endcap display unit and an identical second freestanding endcap display unit oriented with back walls facing each other and being placed into a modular retail display system according to an embodiment.

FIG. 11 illustrates an enlarged view of portions of section views of the back wall of the first freestanding endcap display unit of FIG. 10 abutting the back wall of the second freestanding endcap display unit of FIG. 10 and attachment mechanisms located in attached configurations.

FIG. 12 illustrates a perspective view of a freestanding in-line display unit according to an embodiment.

FIG. 13 illustrates a front view of the freestanding in-line display unit of FIG. 12.

FIG. 14 illustrates a top view of the freestanding in-line display unit of FIG. 12.

FIG. 15 illustrates a section view of the freestanding in-line display unit of FIG. 12 taken through the section line in FIG. 14.

FIG. 16 illustrates an enlarged view of a portion of the section view of the freestanding in-line display unit as indicated in FIG. 15.

FIG. 17 illustrates a section view of the freestanding in-line display unit of FIG. 12 taken through the section line in FIG. 13.

FIG. 18 illustrates an enlarged view of a portion of the section view of the freestanding in-line display unit as indicated in FIG. 17.

FIG. 19 illustrates a perspective view of two of the freestanding endcap display units being attached to a single freestanding in-line display unit to form a modular retail display system according to an embodiment.

FIG. 20 illustrates a top view of two of the freestanding inline display units attached together to form a modular retail display system according to an embodiment.

FIGS. 21a-21c illustrate an attachment mechanism being used to attach freestanding display units together according to an embodiment.

FIGS. 22a-22b illustrate an attachment mechanism being used to attach freestanding display units together according to an embodiment.

FIGS. 23a-23c illustrate a further attachment mechanism being used to further attach freestanding display units together according to an embodiment.

### DETAILED DESCRIPTION

The retail display units described in detail below are mobile, freestanding display units mounted on casters or wheels to create modular retail display systems. Each freestanding display unit includes a base deck equipped with attachment mechanisms to attach the base decks of a plurality of modular freestanding display units together in a variety of different retail display systems.

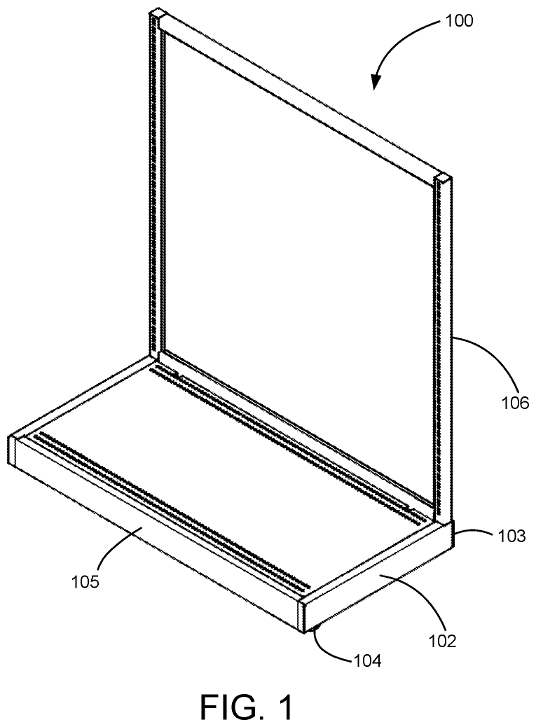

FIG. 1 illustrates a perspective view of a freestanding endcap display unit 100 according to an embodiment. Freestanding endcap display unit 100 is a freestanding display unit that includes a base deck 102. Mounted to base deck 102 are wheels or casters 104 configured to move freestanding endcap display unit 100 about a retail store floor. Coupled to a back end 103 of base 102 is a wall or back wall 106 that extends upwardly from a top of base 102.

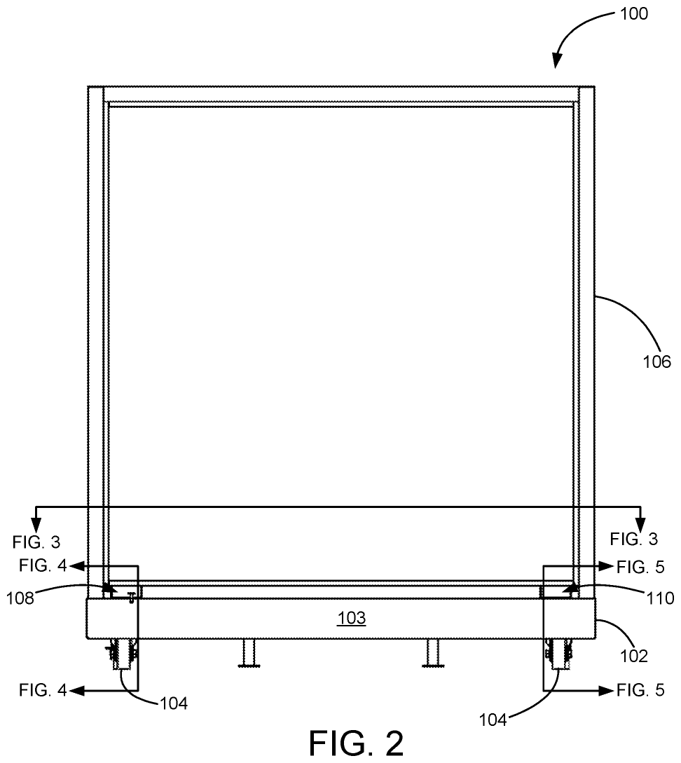

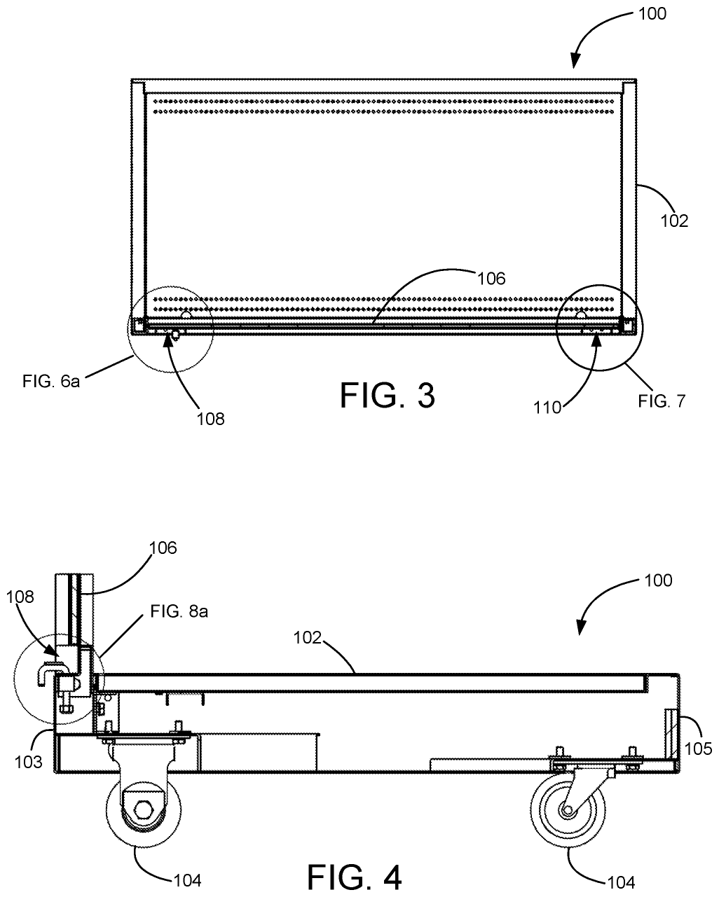

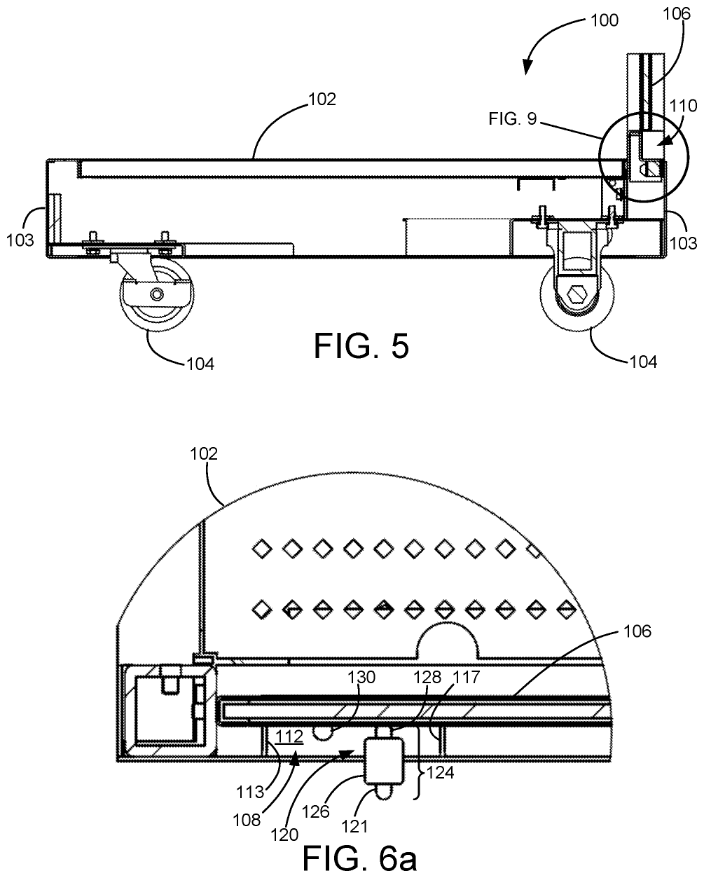

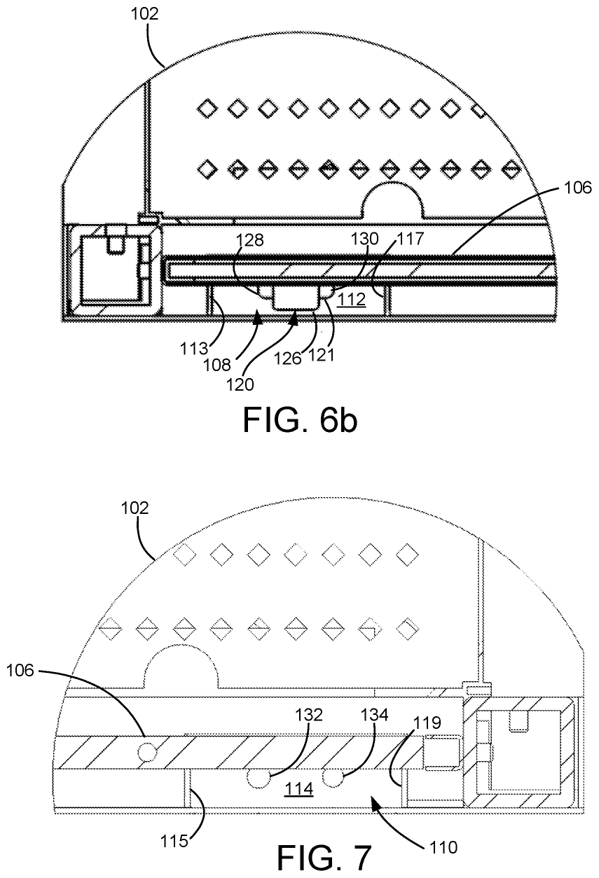

FIG. 2 illustrates a back view of freestanding endcap display unit 100. FIG. 3 illustrates a section view of freestanding endcap display unit 100 taken through the section line in FIG. 2, FIG. 4 illustrates a section view of freestanding endcap display unit 100 taken through the section line in FIG. 2 and FIG. 5 illustrates a section view of freestanding endcap display unit 100 taken through the section line in FIG. 2. As illustrated in FIGS. 2-5, back wall 106 of freestanding endcap display unit 100 includes a pair of cut-outs 108 and 110 on the back side of back wall 106. First cut-out 108 exposes a first portion 112 (FIGS. 6a and 6b) of the top of base deck 102 and second cut-out 110 exposes a second portion 114 (FIG. 7) of the top of base deck 102. First cut-out 108 is located proximate to a back bottom right corner of back wall 106 and second cut-out 110 is located proximate to a back bottom left corner of back wall 106.

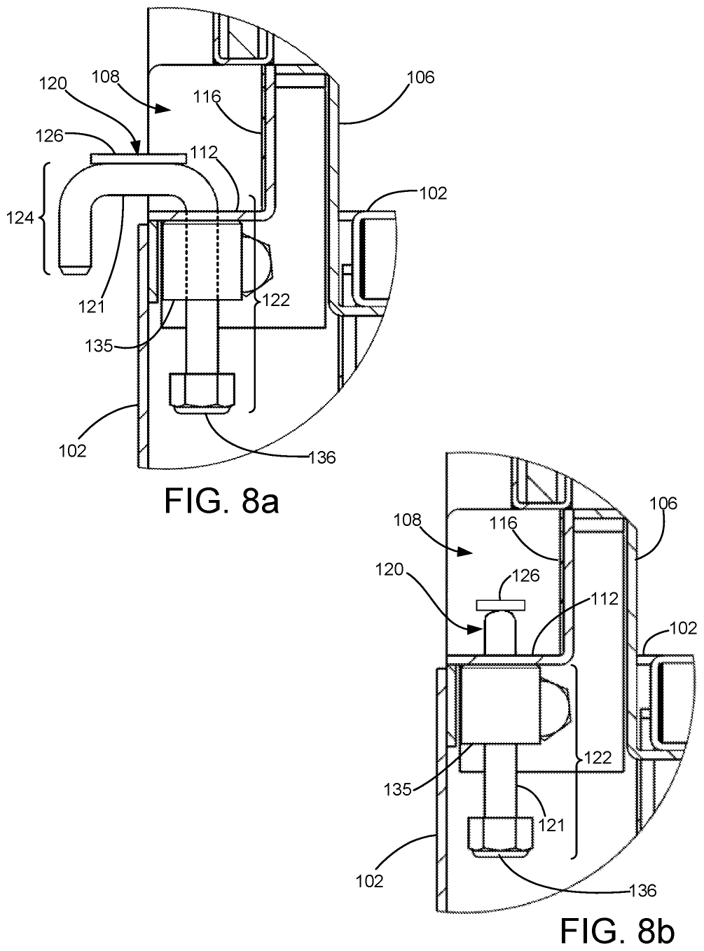

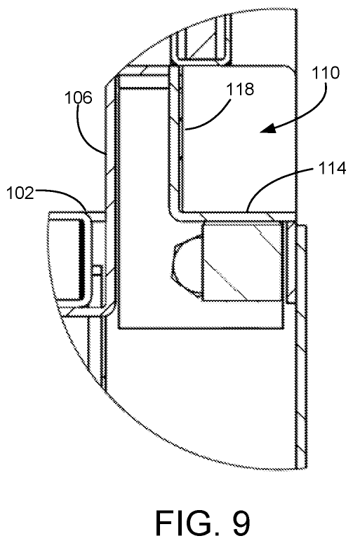

FIG. 6a is an enlarged view of a portion of the section view illustrated in FIG. 3 and illustrates a male-type attachment mechanism 120 extending from first portion 112 of the top of base deck 102 and ready for attachment. FIG. 6b is the enlarged view illustrated in FIG. 6a but with male-type attachment mechanism 120 in a stowed configuration. FIG. 7 is an enlarged view of a portion of the section view in FIG. 3 and illustrates a female-type attachment mechanism in second portion 114 of the top of base deck 102. FIG. 8a is an enlarged view of a portion of the section view in FIG. 4 and illustrates male-type attachment mechanism 120 extending from first portion 112 of the top of base deck 102. FIG. 8b is the enlarged view illustrated in FIG. 8a but with male-type attachment mechanism 120 in the stowed configuration. FIG. 9 is an enlarged view of a portion of the section view in FIG. 5.

First cut-out 108 is defined by portion 112 of the top of base deck 106, a first side 113, a back 116 and a second side 117. Second cut-out 110 is defined by portion 114 of the top of base deck 106, a first side 115, a back 118 and a second side 119. Backs 116 and 118 are recessed from the back side of wall 106 by first side 113, 115 and second side 117, 119. First cut-out 108 houses, provides and makes male-type attachment mechanism 120 accessible from the top of base deck 102, while second cut-out 110 houses, provides and makes the female-type attachment mechanism accessible from the top of base deck 102. It should be realized that in other embodiments, first cut-out 108 may house, provide and make a female-type attachment mechanism accessible from the top of base deck 102 and second cut-out 110 may house, provide and make a male-type attachment mechanism accessible from the top of base deck 102.

First portion 112 of the top of base deck 102 includes a pair of apertures 128 and 130 spaced apart from each other. Situated in first aperture 128 is male-type attachment mechanism 120 that includes a pin 121. As more clearly illustrated in FIGS. 8a and 8b, pin 121 has a main portion 122 and a prong portion 124. Male-type attachment mechanism 120 further includes a plate 126 coupled to a top of pin 121. Pin 121 is rotatable in and inseparable from first aperture 128 by being supported in first aperture 128 with a bushing 135. A free end of main portion 122 of pin 121 includes a stop component 136, for example a lug or lug nut. Main portion 122 extends long enough to be slidable within first aperture 128, however, stop component 136 prevents pin 121 from sliding completely out of first aperture 128. Second aperture 130 is illustrated in FIG. 6a as empty. FIGS. 2, 3, 4, 6a and 8a illustrate pin 121 ready for attachment. In other words, pin 121 is ready to attach freestanding display unit 100 to another freestanding display unit.

FIGS. 6b and 8b illustrate pin 121 in a stowed configuration. In other words, pin 121 in the stowed configuration is in a position that is placed out of the away so as not to interfere with or catch on objects. In the stowed configuration, a free end of prong portion 124 is moved to be situated into second aperture 130. Therefore, in the stowed configuration, pin 121 is simultaneously located in the first aperture 128 and second aperture 130. Stop component 136, again, prevents pin 121 from sliding completely out of second aperture 130 and second aperture 130 provides a resting place for the free end of prong portion 124. As illustrated in FIG. 7, second portion 114 of the top of base deck 102 includes a pair of apertures 132 and 134 spaced apart from each other. Both first and second apertures 132 and 134 may act as female-type attachment mechanism configured to receive the free end of the prong portion of pin 121 of male-type attachment mechanism 120 that is coupled to another freestanding display unit.

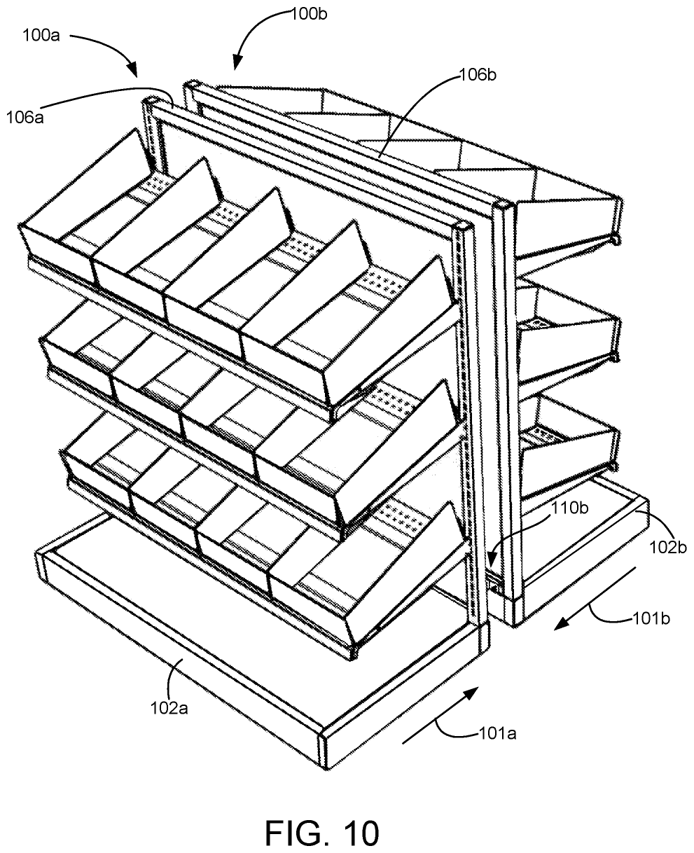

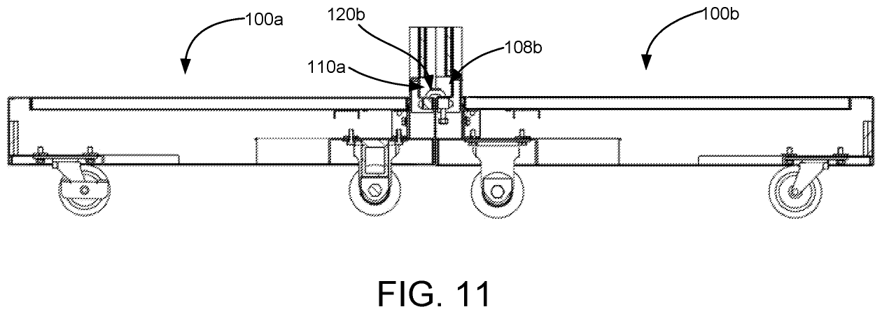

FIG. 10 illustrates a modular retail display system including a first freestanding endcap display unit 100a and an identical second freestanding endcap display unit 100b oriented with back sides of back walls 106a and 106b facing each other and being placed together by moving first freestanding endcap display 100a unit in the direction illustrated by arrow 101a and the second freestanding endcap display unit in the direction illustrated by arrow 101b. FIG. 11 illustrates an enlarged view of the modular retail display system including portions of section views of the back side of back wall 106a of first freestanding endcap display unit 100a abutting the back side of back wall 106b of second freestanding endcap display unit 100b. In FIGS. 10 and 11, male-type attachment mechanism 120b of second freestanding display unit 100b is configured to and engage with a female-type attachment mechanism or one of the pair of apertures (not illustrated but would be labeled as 132a or 134a) of first freestanding display unit 100a and male-type attachment mechanism (not illustrated but would be labeled 120a) of first freestanding display unit 100a is configured to engage with a female-type attachment mechanism or one of the pair of apertures (not illustrated but would be labeled as 132b and 134b) of second freestanding display unit 100b.

As illustrated in FIG. 11, first cut-out 108b of second freestanding display unit 100b faces second cut-out 110a of freestanding display unit 100a Likewise, the first cut-out (not illustrated but would be labeled as 108a) of first freestanding display unit 100a faces the second cut-out 110b (FIG. 10) of second freestanding display unit 100b. In FIG. 11, attachment mechanism 120b that is part of second freestanding display unit 100b is in the attached configuration securing the freestanding display units 100a and 100b together. Not illustrated in FIG. 11, attachment mechanism 120a that is part of first freestanding display unit 100a is in the attached configuration also secures the freestanding display units 100a and 100b together. In this way, freestanding endcap display unit 100 may be configured to pair with another identical freestanding endcap display unit 100 to form a modular retail display system. Alternative modular retail display systems for freestanding endcap display unit 100 will be discussed below.

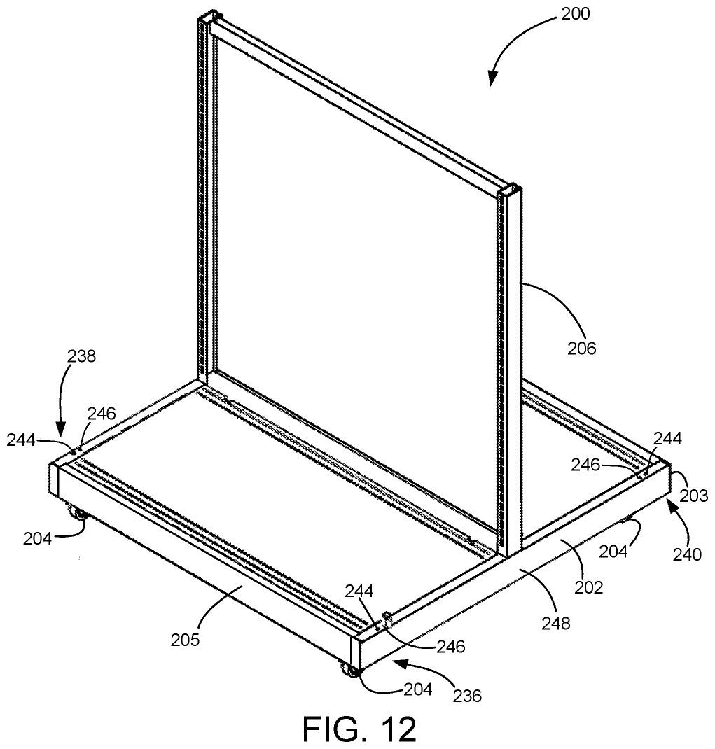

FIG. 12 illustrates a perspective view of a freestanding in-line display unit 200 according to another embodiment. Freestanding in-line display unit 200 is a modular freestanding display unit that includes a base deck 202. Mounted to base deck 202 are wheels or casters 204 configured to move freestanding in-line display unit 200 about a retail store floor. Centrally coupled to base 202 is a wall or center wall 206 that extends upwardly from a mid-point of base deck 202 between a back end 203 and a front end 205 of base deck 202 so that base deck 202 extends in opposite directions from center wall 206.

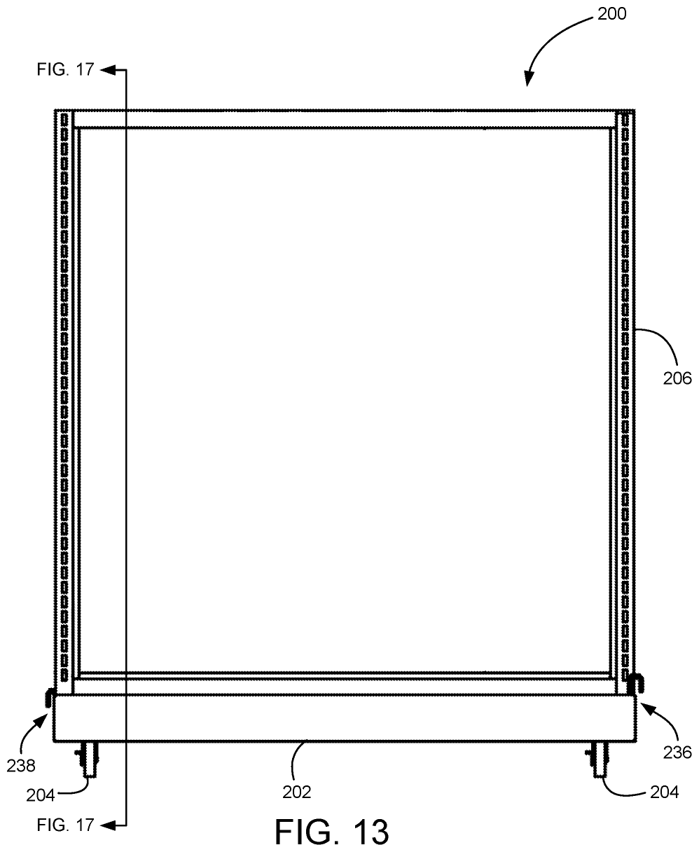

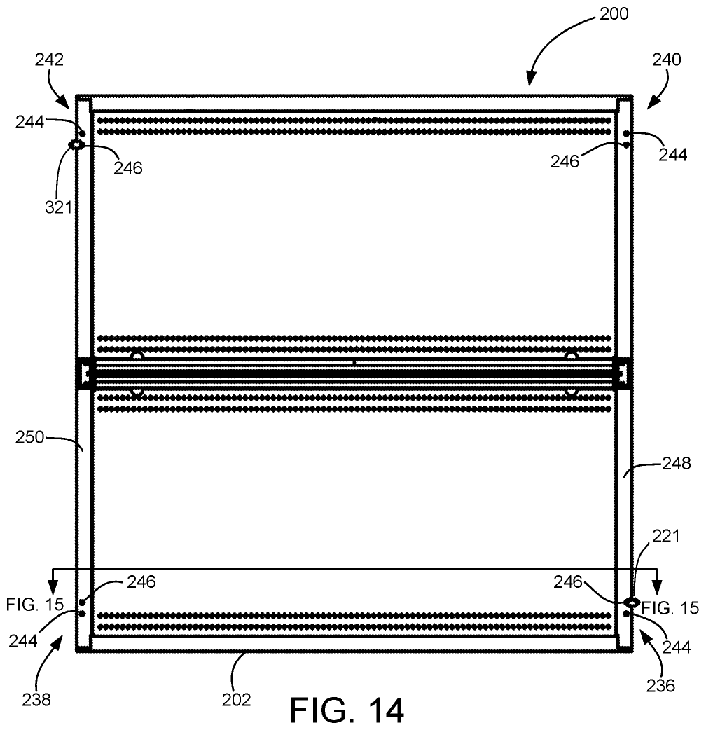

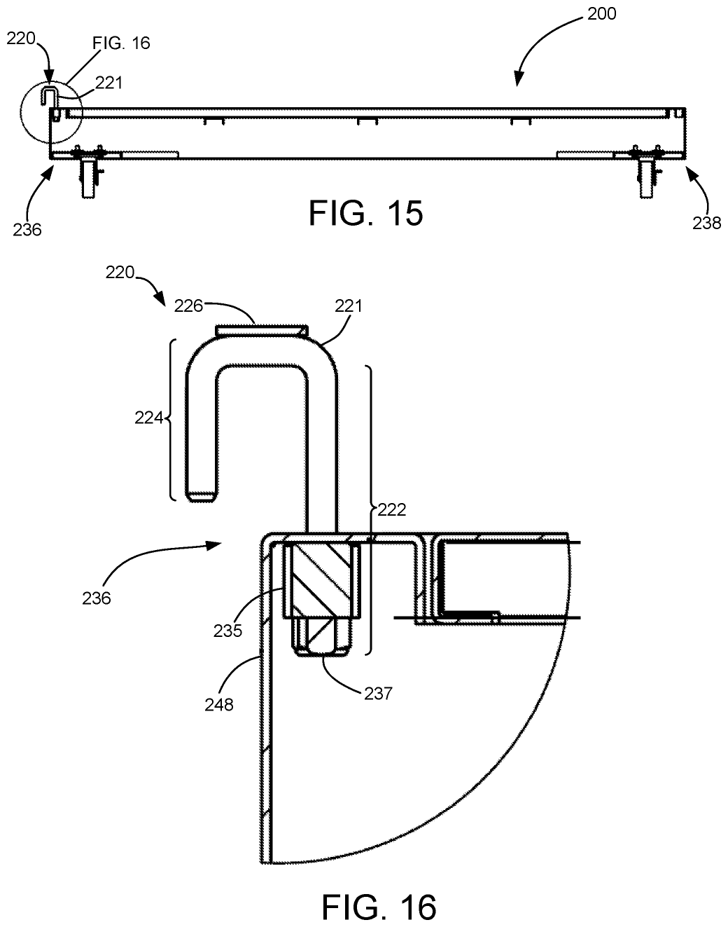

FIG. 13 illustrates a front view of freestanding in-line display unit 200. FIG. 14 illustrates a top view of freestanding in-line display unit 200. FIG. 15 illustrates a section view of freestanding in-line display unit 200 taken through the section line in FIG. 14. As illustrated in FIGS. 12-14, each corner of base deck 202 provides attachment mechanisms to facilitate the attaching of freestanding in-line display unit 200 to other freestanding display units or to freestanding endcap display units 100. Each corner of base deck 202 includes either male-type attachment mechanisms or female-type attachment mechanisms and like types are located in diagonally opposite corners from each other. For example, freestanding in-line display unit 200 includes a first corner 236 illustrated in FIGS. 12-14 as being a front right corner of display unit 200, a second corner 238 illustrated in FIGS. 12-14 as being a front left corner of display unit 200, a third corner 240 illustrated in FIGS. 12-14 as being a back right corner of display unit 200 and a fourth corner 242 illustrated in FIGS. 12-14 as being a back left corner of display unit 200. First corner 236 and fourth corner 242 are diagonally opposite to each other and include male-type attachment mechanisms. Second corner 238 and third corner 240 are diagonally opposite to each other and include female-type attachment mechanisms. It should be realized that in other embodiments, first corner 236 and fourth corner 242 may house and provide female-type attachment mechanisms and second corner 238 and third corner 240 may house and provide male-type attachment mechanisms.

At each corner, a top of base deck 202 includes a pair of apertures 244 and 246 spaced apart from each other. More specifically, base deck 202 includes a right-sided frame member 248 and a left-side frame member 250. Apertures 244 and 246 at first corner 236 and at third corner 240 extend through the top of right-sided frame member 248. Apertures 244 and 246 at second corner 238 and fourth corner 142 extend through the top of left-sided frame member 250. First aperture 244 at first corner 236 and first aperture 244 at fourth corner 242 are illustrated in FIG. 14 as empty. Second aperture 246 at first corner 236 and second aperture 246 at fourth corner 242 are illustrated in FIG. 14 as housing male-type attachment mechanisms 220 and 320. First and second apertures 244 and 246 at each of second corner 238 and third corner 240 are empty. Apertures 244 and 246 at each of second corner 238 and third corner 240 act as female-type attachment mechanisms.

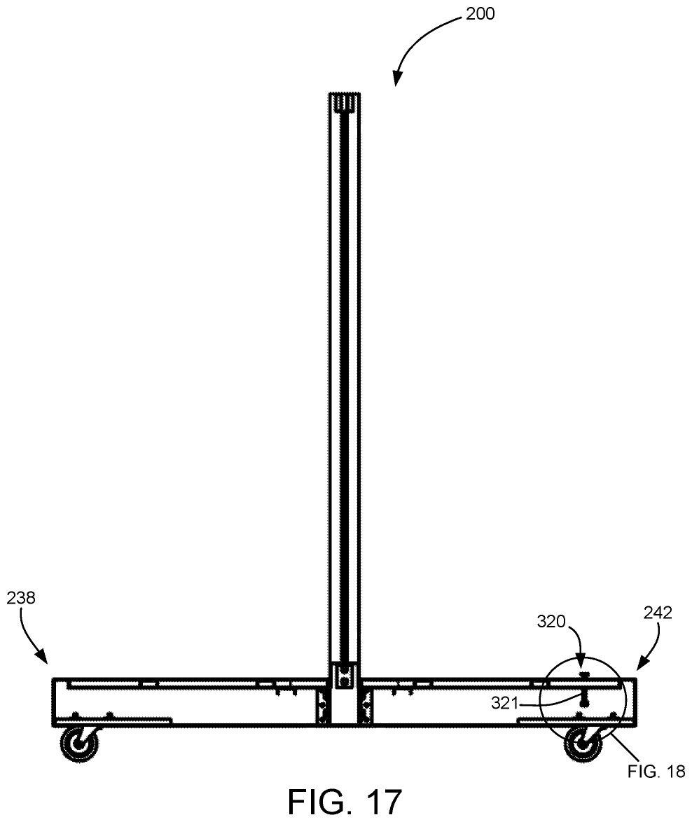

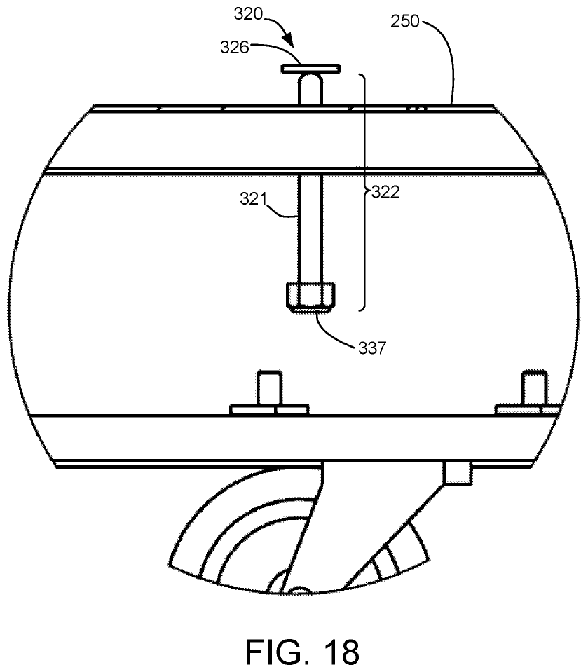

FIG. 15 illustrates a section view of freestanding in-line display unit 200 taken through the section line in FIG. 14. FIG. 16 illustrates an enlarged view of a portion of the section view of the freestanding in-line display unit as indicated in FIG. 15. FIG. 17 illustrates a section view of freestanding in-line display unit 200 taken through the section line in FIG. 13. FIG. 18 illustrates an enlarged view of a portion of the section view of the freestanding in-line display unit as indicated in FIG. 17.

Situated in second aperture 246 at first corner 236 and through frame member 248 is a first pin 221 of a first male-type attachment mechanism 220 of freestanding in-line display unit 200. In other words, first male-type attachment mechanism 220 is located between center wall 206 and front end 205 and proximate a first side of base deck 202. First male-type attachment mechanism 220 includes a first pin 221 having a main portion 222 and a prong portion 224. First male-type attachment mechanism 220 further includes a plate 226 coupled to a top of first pin 221. First pin 221 is rotatable in and inseparable from second aperture 246 and supported with a bushing 235. A free end of main portion 222 of first pin 221 includes a stop component 237. Main portion 222 extends long enough to be slidable within second aperture 246, however, stop component 237 prevents first pin 221 from sliding completely out of second aperture 246. FIGS. 12-16 illustrate first pin 221 ready for attachment. In other words, first pin 221 is posed to attach freestanding in-line display unit 200 to another freestanding display unit, such as another freestanding in-line display unit 200 or to a freestanding endcap display unit 100.

Situated in second aperture 246 at fourth corner 242 and through frame member 250 is a second pin 321 of a second male-type attachment mechanism 320 of freestanding in-line display unit 200. In other words, second male-type attachment mechanism 320 is located between center wall 206 and back end 203 and proximate a second side of base deck 202. Second male-type attachment mechanism 320 includes a second pin 321 having a main portion 322 and a prong portion (not illustrated in FIGS. 17 and 18 but partially illustrated in FIG. 13). Second male-type attachment mechanism 320 further includes a plate 326 coupled to a top of second pin 321. Second pin 321 is rotatable in and inseparable from second aperture 246 and is supported in second aperture 246 with a bushing (not illustrated). A free end of main portion 322 of second pin 321 includes a stop component 337. Main portion 322 extends long enough to be slidable within second aperture 246, however, stop component 337 prevents second pin 321 from sliding completely out of second aperture 246. FIGS. 13-14 and 17-18 illustrate second pin 321 ready for attachment. In other words, second pin 321 is posed to attach freestanding in-line display unit 200 to another freestanding display unit, such as another freestanding in-line display unit 200 or to a freestanding endcap display unit 100.

In stowed configurations, first pin 221 and third pin 321 are placed in positions out of the away so the prong portions of pins 221 and 321 do not interfere with or catch on objects. In the stowed configuration, free ends of prong portions (i.e., 224) are moved to be situated into first apertures 244 at first corner 236 and fourth corner 242. Therefore, in the stowed configuration, first pin 221 is simultaneously located in first aperture 244 and second aperture 246 of first corner 236 and second pin 321 is simultaneously located in first aperture 244 and second aperture 246 of fourth corner 242. First and second apertures 244 and 246 of second corner 238 and third corner 240 act as female-type attachment mechanisms configured to receive prong portions of a pin of a male-type attachment mechanism that is included in another freestanding display unit.

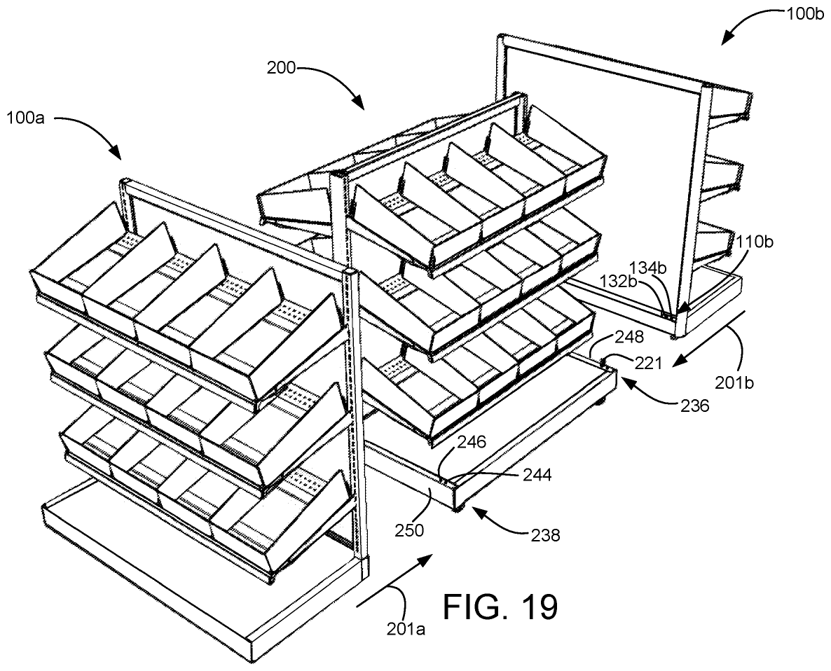

FIG. 19 illustrates a perspective view of two freestanding endcap display units 100a and 100b being attached to a third, single freestanding in-line display unit 200 according to an embodiment. As illustrated, by moving first freestanding endcap display 100a unit in the direction illustrated by arrow 201a and the second freestanding endcap display unit in the direction illustrated by arrow 201b, attachment mechanisms may be used to lock all three display units 100a, 100b and 200 together into a modular retail display system. In particular, the back of freestanding endcap display unit 100a is configured to abut frame member 250 or the second side of freestanding in-line display unit 200 and the back of freestanding endcap display unit 100b is configured to abut frame member 248 or the first side of freestanding in-line display unit 200.

In this position, the first cut-out 108b and second cut-out 110b of freestanding display unit 100b aligns with and faces the first side of freestanding display unit 200. Likewise, the first cut-out and second cut-out of freestanding display unit 100a aligns with and faces the second side of freestanding display unit 200. Each pin in freestanding display units 100a and 100b engage with an aperture in freestanding display unit 200, pin 221 engages with an aperture in freestanding display unit 100b and pin 321 engages with an aperture in freestanding display unit 100a.

For example, first pin 221 of inline display unit 200 engages with an aperture in cut-out 110b of endcap display unit 100b, second pin 321 of inline display unit 200 engages with an aperture in cut-out 110 of endcap display unit 100a, pin 121 located in cut-out 108 of endcap display unit 100a engages with an aperture at second corner 238 of inline display unit 200 and pin 121 located in cut-out 108 of endcap display unit 100b engages with an aperture at third corner 240 of inline display unit 200.

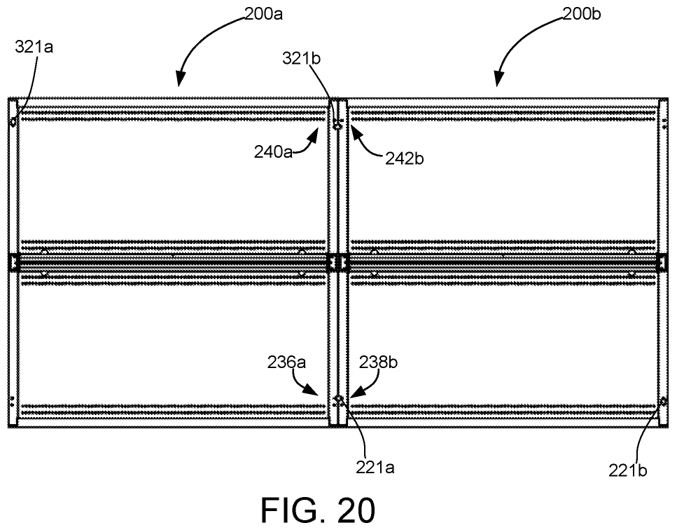

FIG. 20 illustrates a top view of two inline freestanding display units 200a and 200b forming a modular retail display system according to another embodiment. In FIG. 20, first corner 236a of display unit 200a abuts second corner 238b of display unit 200b and pin 221a of display unit 200a engages with an aperture of display unit 200b. Third corner 240a of display unit 200a abuts fourth corner 242b of display unit 200b and pin 321b of display unit 200b engages with an aperture of display unit 200a. Pins 321a and 221b are both in stowed configurations, however, can be lifted and moved to engage with other display units such as an inline display unit 200 or an endcap display unit 100.

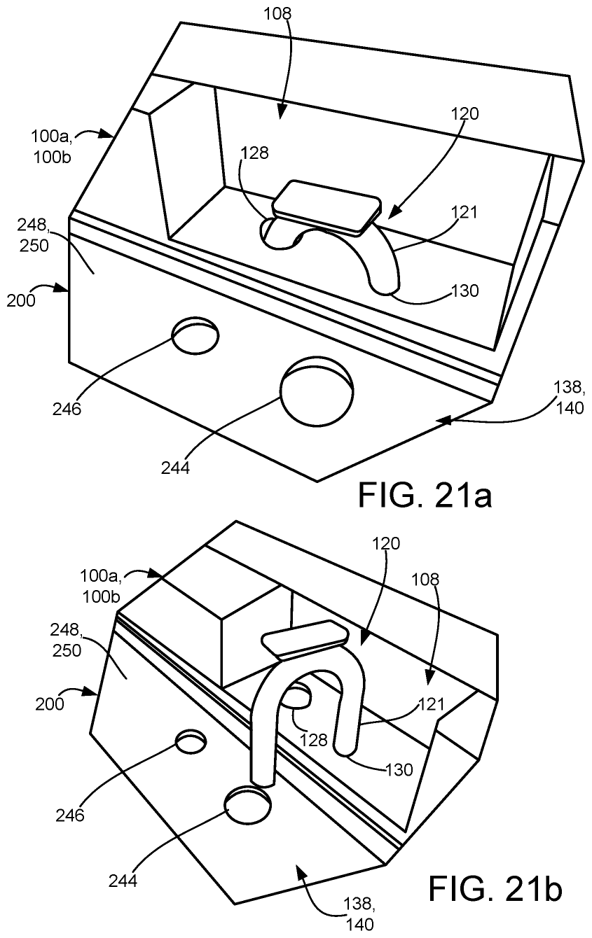

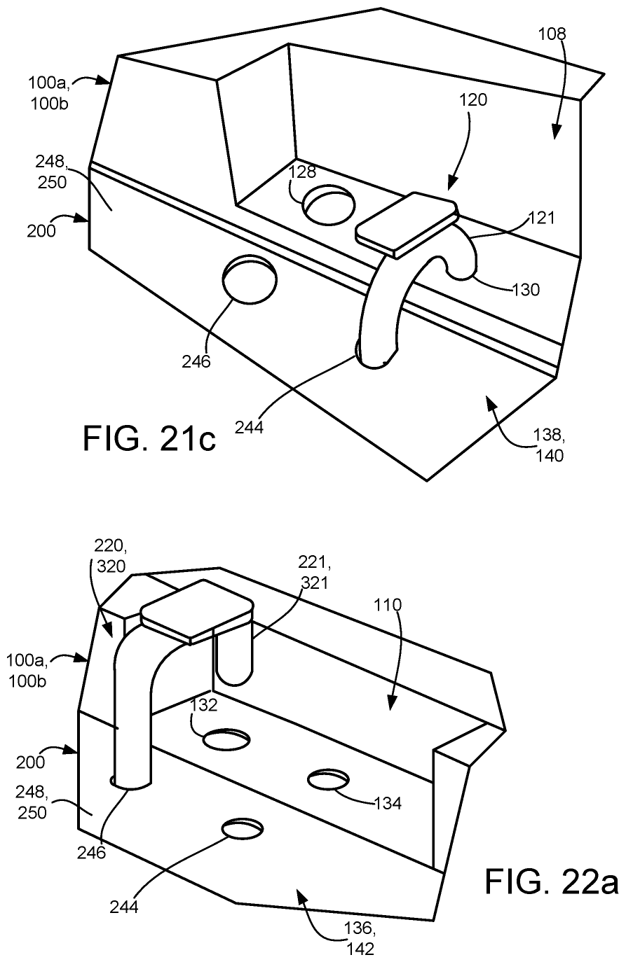

FIGS. 21a-21c illustrate attachment mechanism 120 of freestanding endcap display unit 100a or 100b being used to attach to freestanding inline display unit 200 according to an embodiment. FIG. 21a illustrates pin 121 of attachment mechanism 120 in a stowed configuration. This means that the free end of the prong portion of pin 121 is engaged with first aperture 128 in first cut-out 108, while the main portion of pin 121 is housed in second aperture 130. In addition, first and second apertures 244 and 246 that extend through frame member 248 or 250 of second corner 238 or third corner 240 are empty. In FIG. 21b, pin 121 is being moved from the stowed configuration to an attached configuration. In other words, the free end of the prong portion of pin 121 is removed from first aperture 128 and is rotated to hover over one of first or second apertures 244 or 246. In this illustration, the free end is located above first aperture 244. This movement is accomplished by a person grasping plate 126 with their fingers and manually rotating attachment mechanism 120. In FIG. 21c, pin 121 engages with first aperture 244 of second or third corner 238 or 240 to secure freestanding endcap display unit 100a or 100b to freestanding inline display unit 200. This step is accomplished by the person releasing plate 126.

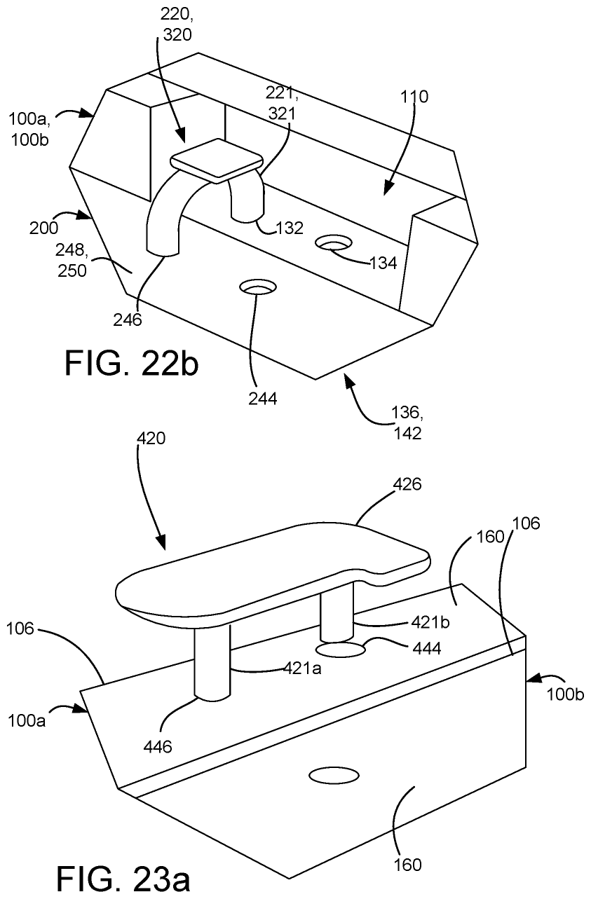

FIGS. 22a-22b illustrate attachment mechanism 220 or 320 of freestanding inline display unit 200 being used to attach freestanding inline display unit 100a or 100b according to an embodiment. FIG. 22a illustrates pin 221 or 321 of attachment mechanism 220 or 320 being moved from a stowed configuration to an attached configuration. In other words, the free end of the prong portion of pin 221 or 321 is removed from first aperture 244 and is rotated to hover over one or first or second apertures 132 or 134 of second cut-out 110 of inline display unit 100a or 100b. In this illustration, the free end is located above first aperture 132. This movement is accomplished by a person grasping plate 226 or 326 with their fingers and manually rotating attachment mechanism 220 or 320. In FIG. 22b, pin 221 or 321 engages with first aperture 132 of cut-out 110 to secure freestanding inline display unit 200 to freestanding endcap display unit 100a or 100b. This step is accomplished by the person releasing plate 226 or 326.

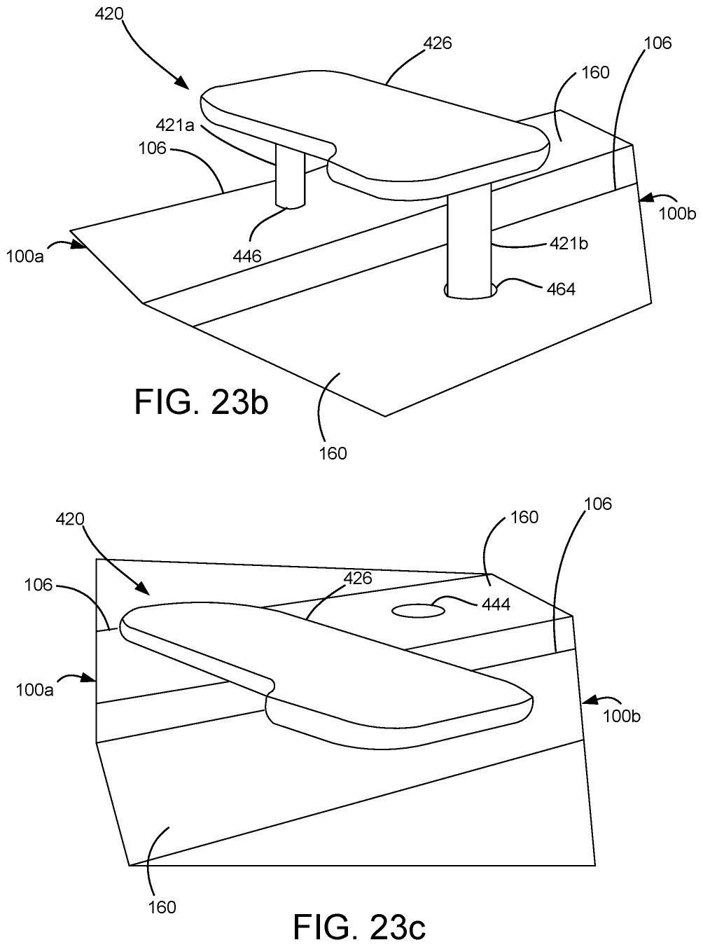

FIGS. 23a-23c illustrate a further attachment mechanism being used to further attach freestanding display units together according to an embodiment. In particular, when back walls 106 of two freestanding endcap display units 100a and 100b are to be secured together, an additional attachment mechanism may be employed. In particular, an attachment mechanism 420 is provided on the upper frame member 160 of back wall 106. Attachment mechanism 420 includes a pair of prongs 421a and 421b depending from a plate 426. Like attachment mechanisms 120, 220 and 320, a portion of the mechanism is rotatable within an aperture and another portion of the mechanism includes a free end. For example, prong 421a is housed in aperture 446 and may be supported in aperture 446 with a bushing and prong 421a may include a stop component 136. Prong 421a extends long enough to be slidable within aperture 446, however, the stop component prevents prong 421a from sliding completely out of aperture 446.

In a stowed configuration, prong 421b engages with an aperture 444 in the upper frame member of back wall 106 of display unit 100a. In such a configuration, attachment mechanism 420 is barely noticeable since plate 426 will lie flat against a surface of the upper frame of back wall 106 of display unit 100a. In FIG. 23b, attachment mechanism 420 is being moved from the stowed configuration to an attached configuration. In other words, the free end of prong 421b is removed from aperture 444 and prong 421a is rotated within aperture 446 so as to hover prong 421b over an aperture 464 in upper frame 160 of back wall 106 of display unit 100b. This movement is accomplished by a person grasping plate 426 with their fingers and manually rotating attachment mechanism 420. In FIG. 23c, prong 421b of attachment mechanism 420 engages with aperture 464 in upper frame of back wall 106 of display unit 100b to further secure freestanding endcap display unit 100a to freestanding endcap display unit 100b. This step is accomplished by the person releasing plate 426.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A modular retail display system comprising:
a first freestanding display unit including a base deck and a wall that extends upwardly from the base deck, wherein the base deck of the first freestanding display unit has at least one male-type attachment mechanism accessible from a top of the base deck and at least one female-type mechanism accessible from the top of the base deck; and
a second freestanding display unit including a base deck and a wall that extends upwardly from the base deck, wherein the base deck of the second freestanding display unit has at least one male-type attachment mechanism accessible from a top of the base deck of the second freestanding display unit and at least one female-type mechanism accessible from the top of the base deck of the second freestanding display unit;
wherein the at least one male-type attachment mechanism of the first freestanding display unit is configured to engage with the at least one female-type attachment mechanism of the second freestanding display unit and the at least one male-type attachment mechanism of the second freestanding display unit is configured to engage with the at least one female-type attachment mechanism of the first freestanding display unit to secure the first freestanding display unit to the second freestanding display unit.

2. The modular retail display system of claim 1, wherein the wall of the first freestanding display unit comprises a back wall that extends upwardly from a back end of the base deck of the first freestanding display unit, the back wall having a first cut-out that exposes a first portion of the top of the base deck first freestanding display unit to access the at least one male-type attachment mechanism of the first freestanding display unit and a second cut-out that exposes a second portion of the top of the base deck of the first freestanding display unit to access the at least one female-type attachment mechanism of the first freestanding display unit.

3. The modular retail display system of claim 2, wherein the wall of the second freestanding display unit comprises a back wall that extends upwardly from a back end of the base deck of the second freestanding display unit, the back wall of the second freestanding display unit having a first cut-out that exposes a first portion of the top of the base deck of the second freestanding display unit to access the at least one male-type attachment mechanism of the second freestanding display unit and a second cut-out that exposes a second portion of the top of the base deck of the second freestanding display unit to access the at least one female-type attachment mechanism of the second freestanding display unit.

4. The modular retail display system of claim 2, wherein the wall of the second freestanding display unit comprises a center wall that extends upwardly from a mid-point of the base deck between a front end and a back end of the base deck of the second freestanding display unit, wherein the at least one male-type attachment mechanism is located between the center wall and the front end and proximate a first side of the base deck of the second freestanding display unit and the at least one female-type attachment mechanism of the second freestanding display unit is located between the center wall and the back end and proximate the first side of the base deck of the second freestanding display unit.

5. The modular retail display system of claim 3, wherein the first cut-out in the back wall of the first freestanding display unit faces the second-cut in the back wall of the second freestanding display unit and the male-type attachment mechanism of the first freestanding display unit engages with the female-type attachment mechanism of the second freestanding display unit and wherein the second cut-out in the back wall of the first freestanding display unit faces the first cut-out in the back wall of the second freestanding display unit and the male-type attachment mechanism of the second freestanding display unit engages with the female-type attachment mechanism of the first freestanding display unit so that the male-type attachment mechanism of the first freestanding display unit and the male-type attachment mechanism of the second freestanding display unit are in attached configurations.

6. The modular retail display system of claim 4, wherein the first cut-out in the back wall of the first freestanding display unit faces the first side of the base deck of the second freestanding display unit and the male-type attachment mechanism of the first freestanding display unit engages with the female-type attachment mechanism of the second freestanding display unit and wherein the second cut-out in the back wall of the first freestanding display unit faces the first side of the base deck of the second freestanding display unit and the male-type attachment mechanism of the second freestanding display unit engages with the female-type attachment mechanism of the first freestanding display unit so that the male-type attachment mechanism of the first freestanding display unit and the male-type attachment mechanism of the second freestanding display unit are in attached configurations.

7. The modular retail display system of claim 1, wherein the wall of the first freestanding display unit comprises a center wall that extends upwardly from a mid-point of the base deck between a front end and a back end of the base deck of the first freestanding display unit, wherein the at least one male-type attachment mechanism is located between the center wall and the front end and proximate a first side of the base deck of the first freestanding display unit and the at least one female-type attachment mechanism of the first freestanding display unit is located between the center wall and the back end and proximate the first side of the base deck of the first freestanding display unit.

8. The modular retail display system of claim 7, wherein the wall of the second freestanding display unit comprises a center wall that extends upwardly from a mid-point of the base deck between a front end and a back end of the base deck of the second freestanding display unit, wherein the at least one male-type attachment mechanism is located between the center wall and the back end and proximate a second side of the base deck of the second freestanding display unit and the at least one female-type attachment mechanism of the second freestanding display unit is located between the center wall and the front end and proximate the second side of the base deck of the second freestanding display unit.

9. The modular retail display system of claim 1, wherein each male-type attachment mechanism comprises a pin having a main portion and a prong portion, wherein the main portion of the pin is slidable in and inseparable from a first aperture in the base deck of respective first or second freestanding display units and wherein each female-type attachment mechanism comprises a second aperture in the base deck of respective first or second freestanding display units, wherein the second aperture of the at least one female-type attachment mechanism of the second freestanding display unit is configured to receive the prong portion of the pin of the at least one male-type attachment mechanism of the first freestanding display unit and the female-type attachment mechanism of the first freestanding display unit is configured to receive the prong portion of the pin of the at least one male-type attachment mechanism of the second freestanding display unit when the male-type attachment mechanisms are in attached configurations.

10. The modular retail display system of claim 9, wherein each of the base decks of the first and second freestanding display units comprises a third aperture spaced apart from but located in proximity to the first aperture that houses the male-type attachment mechanism, wherein the third aperture of the first freestanding display unit is configured to receive the prong portion of the pin of the at least one male-type attachment mechanism of the first freestanding display unit when the at least one male-type attachment mechanism of the first freestanding display unit is in a stowed configuration and wherein the third aperture of the second freestanding display unit is configured to receive the prong portion of the pin of the at least one male-type attachment mechanism of the second freestanding display unit when the at least one male-type attachment mechanism of the second freestanding display unit is in a stowed configuration.

11. The modular retail display system of claim 1, further comprising a third freestanding display unit including a base deck and a wall that extends upwardly from the base deck, wherein the base deck of the third freestanding display unit has at least one male-type attachment mechanism accessible from a top of the base deck of the third freestanding display unit and at least one female-type mechanism accessible from the top of the base deck of the third freestanding display unit.

12. A modular retail display system comprising:
a first mobile display unit including a base deck and a wall that extends upwardly from a top of the base deck, wherein the base deck of the first mobile display unit has at least one pin rotatable in and inseparable from a first aperture and at least one second aperture; and
a second mobile display unit including a base deck and a wall that extends upwardly from a top of the base deck, wherein the base deck of the second mobile display unit has at least one pin rotatable in and inseparable from a first aperture and at least one second aperture;
wherein a prong portion of the at least one pin of the first mobile display unit is configured to engage with the at least one second aperture of the base deck of the second mobile display unit and wherein a prong portion of the at least pin of the second mobile display unit is configured to engage with the at least one second aperture of the base deck of the first mobile display unit to secure the first mobile display unit to the second mobile display unit.

13. The modular retail display system of claim 12, wherein the wall of the first mobile display unit comprises a back wall that extends upwardly from a back end of the base deck of the first mobile display unit, the back wall having a first cut-out that exposes a first portion of the top of the base deck of the first mobile display unit to access the at least one pin of the first mobile display unit and a second cut-out that exposes a second portion of the top of the base deck of the first mobile display unit to access the at least one second aperture of the first mobile display unit.

14. The modular retail display system of claim 13, wherein the wall of the second mobile display unit comprises a back wall that extends upwardly from a back end of the base deck of the second mobile display unit, the back wall of the second mobile display unit having a first cut-out that exposes a first portion of the top of the base deck of the second mobile display unit to access the at least one pin of the second mobile display unit and a second cut-out that exposes a second portion of the top of the base deck of the second mobile display unit to access the at least one second aperture of the second mobile display unit, wherein the first cut-out in the back wall of the first mobile display unit faces the second cut-out in the back wall of the second mobile display unit and the at least one pin of the first mobile display unit engage with the at least one second aperture of the second mobile display unit and wherein the second cut-out in the back wall of the first mobile display unit faces the first cut-out in the back wall of the second mobile display unit and the at least one pin of the second mobile display unit engage with the at least one second aperture of the first mobile display unit so that the at least one pin of the first mobile display unit and the at least one pin of the second mobile display unit are in attached configurations.

15. The modular retail display system of claim 12, wherein each of the base decks of the first and second mobile display units comprise a third aperture, wherein the third aperture of each of the base decks of the first and second mobile display unit are configured to receive the prong portion of the at least one pin of the first mobile display unit when the at least one pin of the first mobile display unit is in a stowed configuration and wherein the third aperture of the second mobile display unit is configured to receive the prong portion of the at least one pin of the second mobile display unit when the at least one pin of the second mobile display unit is in a stowed configuration.

16. The modular retail display system of claim 12, wherein each pin of the first mobile display system and the second mobile display system comprises a plate located on top of each pin for ease in gripping each pin when lifting and rotating each pin.

17. The modular retain display system of claim 12, further comprising a third mobile retail display unit including a base deck and a wall that extends upwardly from a top of the base deck, wherein the base deck of the third mobile display unit has at least one pin rotatable in and inseparable from a first aperture tat accessible from the top of the base deck of the third mobile display unit and at least one second aperture accessible from the top of the base deck of the third mobile display unit.

18. A method of configuring a modular retail display system, the method comprising:
moving a first mobile display unit adjacent to a second mobile display unit, the first mobile display unit including a base deck and a wall that extends upwardly from the base deck and the second mobile display unit including a base deck and a wall that extends upwardly from the base deck, wherein the base deck of the first mobile display unit has at least one pin slidable in and inseparable from a first aperture and at least one second aperture and the second mobile display unit has at least one pin slidable in and inseparable from a first aperture and at least one second aperture;
securing the first mobile display unit to the second mobile display unit by:
lifting the at least one pin of the base deck of the first mobile display unit;
rotating the at least one pin inside the first aperture of the base deck of the first mobile display unit;
inserting a prong portion of the at least one pin of the base deck of the first mobile display unit into the second aperture of the base deck of the second mobile display unit;
lifting the at least one pin of the base deck of the second mobile display unit;
rotating the at least one pin inside the first aperture of the base deck of the second mobile display unit; and
inserting a prong portion of the at least one pin of the base deck of the second mobile display unit into the second aperture of the base deck of the first mobile display unit.

19. The method of claim 18, wherein lifting the at least one pin of the base deck of the first mobile display unit comprises lifting the prong portion of the at least one pin out of a third aperture of the base deck of the first mobile display unit where the prong portion was being stowed and wherein lifting the at least one pin of the base deck of the second mobile display unit comprising lifting the prong portion of the at least one pin out of a third aperture of the base deck of the second mobile display unit where the prong portion was being stowed.

20. The method of claim 18, wherein lifting and rotating the at least one pin of the base deck of the first mobile display unit comprises lifting and rotating a plate coupled to a top of the at least one pin of the base deck of the first mobile display unit and wherein lifting and rotating the at least one pin of the base deck of the second mobile display unit comprises lifting and rotating a plate coupled to a top of the at least one pin of the base deck of the second mobile display unit.
